(19) United States
(12) Patent Application Publication
(10) Pub. No.: US 2024/0136525 A1
(43) Pub. Date: Apr. 25, 2024

(54) ANODE ACTIVE MATERIAL, AND HIGH-CAPACITY SECONDARY BATTERY FOR FAST CHARGING COMPRISING THE SAME

(71) Applicant: THE INDUSTRY & ACADEMIC COOPERATION IN CHUNGNAM NATIONAL UNIVERSITY (IAC), Daejeon (KR)

(72) Inventors: Seung-Wan SONG, Sejong (KR); Dong Guk Kang, Daejeon (KR); Thi Hai Yen TRAN, Daejeon (KR)

(21) Appl. No.: 18/483,835

(22) Filed: Oct. 10, 2023

(30) Foreign Application Priority Data
Oct. 11, 2022 (KR) 10-2022-0129991
Jul. 20, 2023 (KR) 10-2023-0094250

(51) Int. Cl. H01M 4/587; H01M 4/36; H01M 4/48; H01M 10/0525

(52) U.S. Cl. CPC H01M 4/587; H01M 4/364; H01M 4/483; H01M 10/0525; H01M 2004/027

(57) ABSTRACT

An anode active material and a high-capacity secondary battery for high speed charging including the same are described. When an anode active material including a composite material in which a high-capacity silicon-based anode active material and a graphite active material capable of enabling high-speed charging by increasing the interlayer distance are mixed is used as an anode, the high-speed charging performance of a secondary battery can be improved and the capacity thereof can be increased, and a secondary battery that can be mounted on small and medium-sized electronic devices such as portable phones and the like, various electric mobilities including commercial electric vehicles, and energy storage systems (ESS) can be provided.

### CROSS-REFERENCE TO RELATED APPLICATION

This application claims priority to Korean Patent Application No. 10-2022-0129991, filed on Oct. 11, 2022, and, No. 10-2023-0094250, filed on Jul. 20, 2023, in the Korean Intellectual Property Office, each of which is incorporated herein in its entirety by reference.

### TECHNICAL FIELD

The present invention relates to an anode active material and a high-capacity secondary battery for high speed charging including the same.

### BACKGROUND ART

A lithium secondary battery consists of a cathode, an anode, a separator, and an electrolyte solution, and the anode is a counter electrode storing energy by intercalating and deintercalating lithium ions that are deintercalated and intercalated during charging and discharging of the cathode and moved, and completes the charge and discharge cycles of a secondary battery using lithium.

In general, a graphite anode is used in a lithium ion battery, and a staging phenomenon occurs due to the inherent characteristics of graphite having a high degree of structural order, and the lithium ion battery is charged at a slow rate until one lithium ion per six carbons is intercalated. In particular, graphite-based active materials have characteristics that are disadvantageous for high-speed use of batteries, such as requiring charging and discharging times of 20 hours or more each to achieve a theoretical capacity of 372 mAh/g. The theoretical capacity is also limited so that there are disadvantageous characteristics in that there is also a limitation in capacity increase.

While focusing on a technology for increasing the mileage of electric vehicles and charging them quickly at the same time, that is, improvement in the energy density of secondary batteries and improvement in high-speed charging performance as the commercialization of electric vehicles has recently been actively progressed, the above-described characteristics are becoming the biggest factor that makes it difficult to apply anodes to electric vehicle batteries only with the graphite material that most occupies the lithium secondary battery market.

As one of the materials that are in the spotlight as an anode material for secondary batteries, silicon (Si) is an anode material with a theoretical capacity of 4,200 mAh/g, and there are advantages in that it has a very high capacity, a low potential difference with lithium, and abundant reserves.

However, although silicon theoretically has a high theoretical capacity as described above, there is a problem in that the capacity rapidly deteriorates when charging and discharging are continued due to the problem of volume expansion.

In order to solve such a problem, an anode active material in which silicon and graphite are complexed has been developed.

However, even in the case of the anode active material in which silicon and graphite are complexed as described above, there is a limitation in its use for high speed charging due to the slow charging speed of graphite.

### RELATED ART DOCUMENT

### Patent Document

(Patent Document 0001) KR 10-1795778 B1

### DISCLOSURE

### Technical Problem

In order to solve the problems as described above, an object of the present invention is to provide an anode active material capable of improving the high-speed charging performance of the secondary battery and increasing the capacity of the secondary battery when used as an anode of a secondary battery by including a graphite active material and a silicon-based active material that have an increased interlayer distance.

In addition, another object of the present invention is to provide a secondary battery that can be mounted on small and medium-sized electronic devices such as portable phones, various electric mobilities including commercial electric vehicles, and energy storage systems (ESS).

### Technical Solution

An anode active material of the present invention for achieving the above object includes a graphite active material and a silicon-based active material, wherein the graphite active material may have an interlayer distance d₀₀₂ increased by 0.001 Å to 0.003 Å.

The silicon-based active material and the graphite active material may be included at a weight ratio of 1:99 to 99:1.

The graphite active material may be a natural graphite active material or an artificial graphite active material.

The artificial graphite active material may have an interlayer distance d₀₀₂ of 3.368 Å to 3.370 Å.

The silicon-based active material may be selected from the group consisting of silicon (Si), silicon oxides (SiO and SiOₓ (1<x≤2)), silicon alloys (alloys), silicon nanotubes, silicon nanowires, and mixtures thereof.

The lithium secondary battery including the anode active material may have a discharge capacity per weight of 400 mAh/g or more during 1 C charging and discharging and a capacity retention rate of 90 to 99%.

The graphite active material may have a BET specific surface area increased by 127% or more.

An anode for a secondary battery according to another embodiment of the present invention may include the anode active material.

A secondary battery according to another embodiment of the present invention may include the anode for a secondary battery.

The anode for a secondary battery may have a discharge capacity per weight of more than 374 mAh/g to less than 2,500 mAh/g during 1 C charging and discharging, and may enable a 1 C to 3 C charge cycle.

A method for preparing an anode active material according to another embodiment of the present invention includes the steps of: supporting graphite in an organic solvent; low-temperature treating graphite supported in the organic solvent; drying low-temperature treated graphite; and mixing dried graphite with a silicon-based active material, wherein graphite may have an interlayer distance d₀₀₂ increased by 0.001 Å to 0.003 Å.

The organic solvent may be selected from the group consisting of a linear alcohol-based organic solvent, a linear carbonate-based organic solvent, a cyclic carbonate-based organic solvent, a linear ester-based organic solvent, a ketone-based organic solvent, and mixtures thereof.

The low-temperature treatment may be performed at 0 to −40° C. for 0.1 to 168 hours.

### Advantageous Effects

The anode active material according to the present invention is one including a graphite active material that have an increased distance between graphite layers and a silicon-based active material and can greatly improve high-speed charge performance of the secondary battery when used as an electrode for a secondary battery.

In addition, the secondary battery provided by the present invention improves high-speed charge performance and performance per weight, which are reasons why it is difficult to apply existing secondary batteries to electric vehicles, thereby enabling high-speed charging and weight reduction, which are key elements in the electric vehicle technology development, to be simultaneously achieved.

### MODE FOR INVENTION

Hereinafter, embodiments of the present invention will be described in detail so that those skilled in the art to which the present invention pertains can easily carry out the present invention. However, the present invention may be embodied in a variety of different forms and is not limited to the embodiments described herein.

The anode material included in a lithium secondary battery accounts for about 15% of the material cost of a lithium ion battery, and is the third most material after a cathode material and a separator, but it is a counter electrode material for cathode materials, and is a key material that determines the performance such as battery capacity.

Types of currently used graphite anode material types may be classified into natural graphite and artificial graphite.

Since an anode material prepared using natural graphite is produced and processed from underground resources and then prepared, its price competitiveness is superior to artificial graphite, and the initial charging efficiency is 90% or more due to the development of surface treatment or spheronization technology so that its amount of use is expanding.

The anode material prepared using artificial graphite is prepared by performing firing and carbonization treatment of cokes and pitch as raw materials and heating them again in an electric furnace at a high temperature of up to 3,000° C. so that it may have a more excellent lifespan than natural graphite, but may be less competitive in price than natural graphite.

However, as described above, the graphite active material has problems in that a staging phenomenon occurs due to the inherent characteristics of graphite having a high degree of structural order, and a charging speed is slow until one lithium ion per six carbons is intercalated. In particular, graphite-based active materials have characteristics that are disadvantageous for high-speed use of batteries, such as requiring charging and discharging times of 20 hours or more each to achieve a theoretical capacity of 372 mAh/g.

In order to solve these problems, anode active materials have been tried to be prepared by various methods such as conventional surface treatment or spheronization process, high-temperature treatment of 1,200° C. or more, and the like, but manufacturing cost is high, or there is an intrinsic limitation in high-speed charging so that there is a problem in that it is not suitable for applying the methods to high-speed charging technology of electric vehicles for long-distance driving.

Accordingly, the present invention is characterized in that the high-speed charge and discharge cycle performance of a secondary battery is improved, and the capacity thereof is increased by including a graphite active material and a silicon-based active material that have not been subjected to surface treatment or a high-temperature process.

Specifically, the graphite active material according to one embodiment of the present invention is characterized in that the interlayer distance d₀₀₂ is increased by 0.001 Å to 0.003 Å.

The graphite active material is characterized in that it has a layered structure in terms of crystal structure.

Specifically, in the crystal structure of graphite, carbon atoms in sp² hybrid orbitals combine with each other in a hexagonal plane to form a carbon hexagonal plane (graphene layer), and π electrons positioned on the top and bottom of the carbon plane bind the carbon hexagonal plane.

Since the π electrons can be relatively freely moved between carbon hexagonal planes, graphite has excellent electronic conductivity. The π bond bonding between such graphite layers forms a weak van der Waals bond, but the bond inside the carbon hexagonal plane is made up of a very strong covalent bond to show anisotropy. Lithium ions are intercalated and deintercalated between such graphite layers. Graphite active material basically means hexagonal graphite in which graphite layer planes are stacked in the ABAB method in the c-axis direction, but the stacking order may be partially modified to include rhombohedral graphite structure in which the graphite layer planes are stacked in the ABCABC method.

The graphite active material is subjected to a reduction reaction during charging so that, when lithium ions are intercalated into the layered structure of graphite, a compound of LiₓC is formed, and at this time, the interlayer stacking method is changed to the AAAA method. Meanwhile, during discharging, lithium ions are deintercalated while an oxidation reaction occurs in graphite.

During charging and discharging as described above, electrochemical properties such as reaction potential and lithium storage capacity may differ depending on crystallinity, microstructure, and particle shape of the graphite active material.

However, in general, the interlayer distance d₀₀₂ in the crystal structure of the graphite active material may be 3.359 to 3.367 Å in the case of artificial graphite, and may be 3.355 to 3.550 Å in the case of natural graphite. However, in the case of natural graphite, since it is not artificially manufactured, the interlayer distance is not limited to the above-described range and may vary.

Within the interlayer distance as described above, lithium ions are intercalated during charging and deintercalated during discharging.

Accordingly, in the present invention, the interlayer distance d₀₀₂ of the graphite active material is increased by 0.001 Å to 0.003 Å, and thus the charging speed and charging capacity may be increased.

As described above, when charging the lithium secondary battery, the mechanism is that lithium ions are intercalated into the layered structure of the graphite active material, which is an anode material, to form a LiₓC compound.

Therefore, as in the present invention, when the interlayer distance d₀₀₂ of the graphite active material is increased by 0.001 Å to 0.003 Å, the intercalation of lithium ions is smoothly performed, and as the amount of lithium ions that can be intercalated increases, the charging capacity of the lithium secondary battery may be increased.

The graphite active material according to one embodiment of the present invention is a natural graphite active material having an increased interlayer distance from normal natural graphite, and the interlayer distance d₀₀₂ of the natural graphite active material may be 3.360 Å to 3.365 Å. A general natural graphite active material has an interlayer distance d₀₀₂ of 3.355 to 3.550 Å, and the natural graphite active material of the present invention is one having an interlayer distance d₀₀₂ of a natural graphite active material used as an existing anode material increased by 0.001 to 0.003 Å.

The silicon-based active material may be selected from the group consisting of nano-sized silicon, micro-sized silicon, silicon oxide (SiO and SiOₓ (1<x≤2)), silicon alloy, silicon nanotubes, silicon nanowires and mixtures thereof, materials having their surfaces coated with carbon on their surfaces, and carbon composites thereof.

Silicon oxide SiO can implement a battery capacity of 1,500 mAh per 1 g, and silicon is an anode active material which can implement a battery capacity of 3,572 mAh, which has an energy density higher than those of graphite-based anode active materials, and which has a fast rate of accepting lithium ions so that the charging time of lithium ion secondary batteries can be shortened.

Silicon-based anode active materials have already been used in small electronic products and equipment such as smartphones and the like since the early 2010s, but they are still applied only in a limited content of less than 5% as a weight ratio due to their high volume expansion rate (up to 40 times) compared to the graphite-based anode active materials, and there is a limitation in applying them as a large amount of an anode active material.

Various methods have been developed in order to solve such problems, but they have been intended to solve the volume expansion problem of the silicon active material by generally preparing a carbon-silicon composite.

However, in the case of the existing carbon-silicon composite, there is a limitation in the charging speed due to the slow charging speed of graphite.

Therefore, when, as an anode active material including a graphite active material having an increased interlayer distance d002 as described above and a silicon-based active material in the present invention, a graphite active material with improved advantages and disadvantages of a silicon-based anode active material is mixed so that the mixture is applied to a secondary battery, it is characterized by having an increased capacity and excellent charging speed.

The silicon-based active material and the graphite active material may be included at a weight ratio of 1:99 to 99:1, and may be included at a weight ratio of 1:9 to 7:3, but are not limited to the above examples. When the silicon-based active material and the graphite active material are included within the above-described ranges, the discharge capacity per weight is large during charging and discharging at 1 C (charging within 1 hour), and ultra-high speed charging from minute units to second units at a current density higher than 1 C is possible.

The silicon-based active material may be selected from the group consisting of silicon (Si), silicon oxide (SiO and SiOₓ (1<x≤2)), silicon alloy (alloy), silicon nanotubes, silicon nanowires, and mixtures thereof.

Silicon (Si) may be nano-sized silicon particles or micro-sized silicon particles, but is not limited to the above examples, and all may be used without limitation.

In addition, as the silicon-based active material, not only the previously exemplified silicon-based active material, but also both of a material coated with carbon on the outer portion of the silicon-based active material and a composite material in which the silicon-based active material is mixed with carbon can be used without limitation.

The silicon-based active material may be preferably selected from the group consisting of silicon particles (Si), silicon oxide (SiOx), silicon alloys (alloys), and mixtures thereof, and may be more preferably selected from the group consisting of nano-sized silicon particles (Si), silicon oxide (SiO), and a mixture thereof, but is not limited to the above examples, and any material that can be used as a silicon-based active material may be used without limitation.

The lithium secondary battery including the anode active material of the present invention may have a discharge capacity per weight of 350 to 3,200 mAh/g at 0.1 C charge and discharge, preferably 380 to 1,200 mAh/g, and more preferably 390 to 920 mAh/g. In addition, the capacity retention at 0.1 C charge and discharge is 100%, the discharge capacity retention during 0.2 C charge (5 hour charge) cycle is 99% or more, the discharge capacity retention during 0.5 C charge (2 hour charge) cycle is 98% or more, the discharge capacity retention during 1 C charge (1 hour charge) cycle is 97% or more, the discharge capacity retention during 2 C charge (30 minute charge) cycle is 97% or more, and the discharge capacity retention during 3 C charge (20 minute charge) cycle is 94% or more. In this way, the discharge capacity retention during 600 C ultra-high speed charging (6 second charge; 2 second charge in case of full cell) cycle may be 85% or more.

Even when the charging and discharging conditions are different as described above, an excellent capacity retention rate can be maintained, and thus the high-speed charging effect is very excellent.

The lithium secondary battery including the anode active material of the present invention may have a discharge capacity per weight at 1 C charge and discharge of more than 350 mAh/g to less than 2,500 mAh/g, 400 mAh/g to 1,450 mAh/g, and 450 mAh/g to 1,400 mAh/g. This is very excellent in discharge capacity per weight compared to conventional lithium secondary batteries.

The lithium secondary battery including the anode active material of the present invention may have a discharge capacity per weight at 600 C charge of more than 350 mAh/g to less than 1,200 mAh/g, 400 mAh/g to 1,000 mAh/g, and 450 mAh/g to 700 mAh/g. This is very excellent in discharge capacity per weight despite ultra-high speed charging compared to conventional lithium secondary batteries.

The graphite active material is a natural graphite active material, and the natural graphite active material may have an interlayer distance d₀₀₂ of 3.362 Å to 3.363 Å.

A general natural graphite active material has an interlayer distance d₀₀₂ of 3.355 to 3.550 Å, and the natural graphite active material of the present invention increases the interlayer distance d₀₀₂ of the natural graphite active material used as a conventional anode material by 0.001 to 0.003 Å.

As described above, the increase in the interlayer distance d₀₀₂ of the graphite active material can be more clearly confirmed through the increase in the specific surface area.

The graphite active material is characterized by having a BET specific surface area increased by 127% or more. Specifically, the artificial graphite active material has a BET specific surface area increased by 127% to 130%, and the natural graphite active material has a BET specific surface area increased by 127% to 150%.

As described above, the increase in the interlayer distance d₀₀₂ and the BET specific surface area of the graphite active material may increase the interlayer distance of the crystal structure, thereby increasing the intercalation rate of lithium ions during charging and increasing the charging capacity.

However, when the interlayer distance increases beyond the above-described range, there is a problem in that lithium ions cannot be fixed between the graphite layers, and when the distance increases below the above-described range, an effect of increasing the charging speed and an effect of increasing the charging capacity according to the increase in the interlayer distance may be inadequate.

Another embodiment of the present invention relates to a method for preparing a graphite active material, the method including the steps of: supporting graphite in an organic solvent; low-temperature treating graphite supported in the organic solvent; drying low-temperature treated graphite; and mixing dried graphite with a silicon-based active material, and the interlayer distance d₀₀₂ may be increased by 0.001 Å to 0.003 Å.

Graphite is a natural graphite active material or artificial graphite active material that can be used as a graphite active material, but is not limited to the above examples, and any material that can be used as the graphite active material can be used without limitation.

The organic solvent may be selected from the group consisting of a linear alcohol-based organic solvent, a linear carbonate-based organic solvent, a cyclic carbonate-based organic solvent, a linear ester-based organic solvent, a ketone-based organic solvent, and mixtures thereof.

The alcohol-based organic solvent may be methyl alcohol, ethyl alcohol, propyl alcohol, 2-propyl alcohol, 1-butyl alcohol, 2-butyl alcohol, isobutyl alcohol, tert-butyl alcohol, or the like.

The linear carbonate-based organic solvent may be dimethyl carbonate, ethyl methyl carbonate, diethyl carbonate, methyl propyl carbonate, ethyl propyl carbonate, dipropyl carbonate, or the like.

The cyclic carbonate-based organic solvent may be ethylene carbonate (EC), propylene carbonate (PC), or the like.

In addition, fluorinated cyclic carbonate-based organic solvents such as fluoroethylene carbonate (FEC), 4,4-difluoroethylene carbonate, 4,5-difluoroethylene carbonate, 4-methyl-5-fluoroethylene carbonate, 4-methyl-5,5-difluoroethylene carbonate, 4-(fluoromethyl)ethylene carbonate, 4-(difluoromethyl)ethylene carbonate, 4-(trifluoromethyl)ethylene carbonate, 4-(2-fluoroethyl)ethylene carbonate, 4-(2,2-difluoroethyl)ethylene carbonate, and 4-(2,2,2-trifluoroethyl)ethylene carbonate may also be used.

Fluorinated dimethyl carbonate-based organic solvents such as fluoromethylmethyl carbonate, difluoromethylmethyl carbonate, trifluoromethylmethyl carbonate, bis(fluoromethyl) carbonate, bis(difluoromethyl) carbonate, bis(trifluoromethyl) carbonate, (fluoromethyl)(difluoromethyl) carbonate, (fluoromethyl)(trifluoromethyl) carbonate, and (difluoromethyl)(trifluoromethyl) carbonate may also be used.

Fluorinated diethyl carbonate-based organic solvents such as 2-fluoroethylethyl carbonate, 2,2-difluoroethylethyl carbonate, 2,2,2-trifluoroethylethyl carbonate, bis(2-fluoroethyl) carbonate, bis(2,2-difluoroethyl) carbonate, bis(2,2,2-trifluoroethyl) carbonate, (2-fluoroethyl)(2,2-difluoroethyl) carbonate, (2-fluoroethyl)(2,2,2-trifluoroethyl) carbonate, and (2,2-difluoroethyl)(2,2,2-trifluoroethyl) carbonate may also be used.

Fluorinated ethylmethyl carbonate-based organic solvents such as 2-fluoroethylmethyl carbonate, 2,2-difluoroethylmethyl carbonate, 2,2,2-trifluoroethylmethyl carbonate, (2-fluoroethyl)(fluoromethyl) carbonate, (2-fluoroethyl)(difluoromethyl) carbonate, (2-fluoroethyl)(trifluoromethyl) carbonate, (2,2-difluoroethyl)(fluoromethyl) carbonate, (2,2-difluoroethyl)(difluoromethyl) carbonate, (2,2-difluoroethyl)(trifluoromethyl) carbonate, (2,2,2-trifluoroethyl)(fluoromethyl) carbonate, (2,2,2-trifluoroethyl)(difluoromethyl) carbonate, and (2,2,2-trifluoroethyl)(trifluoromethyl) carbonate may also be used.

The linear ester-based organic solvent may be methyl acetate, ethyl acetate, methyl propionate, ethyl propionate, or the like.

In addition, fluorinated linear ester-based organic solvents such as fluoromethyl acetate, difluoromethyl acetate, trifluoromethyl acetate, 2-fluoroethyl acetate, 2,2-difluoroethyl acetate, 2,2,2-trifluoroethyl acetate, fluoromethyl propionate, difluoromethyl propionate, trifluoromethyl propionate, 2-fluoroethyl propionate, 2,2-difluoroethyl propionate, and 2,2,2-trifluoroethyl propionate may also be used.

The ketone-based organic solvent may be acetone, methyl ethyl ketone, diethyl ketone, or the like.

In addition, fluorinated ketone-based organic solvents such as 1-fluoropropan-2-one, 1,1-difluoropropan-2-one, 1,1,1-trifluoropropan-2-one, 1,3-difluoropropan-2-one, 1,1,3-trifluoropropan-2-one, 1,1,1,3-tetrafluoropropan-2-one, 1,1,3,3-tetrafluoropropan-2-one, 1,1,1,3,3-pentafluoropropan-2-one, and 1,1,1,3,3,3-hexafluoropropan-2-one may also be used.

The low-temperature treatment may be performed at a temperature of 0 to −40° C. for 0.1 to 168 hours. At this time, the temperature is preferably −5 to −35° C., more preferably −10 to −30° C.

When the graphite active material is treated under the supported solvent and low-temperature treatment conditions as described above, the interlayer distance of the graphite active material increases so that when used as an anode material for a lithium secondary battery, the charging speed can be improved, and the charging capacity can be increased.

In addition, the charging speed can be greatly improved, and the capacity can also be increased when a conventional anode active material is used as an anode active material including a graphite active material with an increased interlayer distance and a silicon-based active material compared to when only a graphite active material with an increased interlayer distance is used as an anode active material.

Another embodiment of the present invention relates to an anode for a secondary battery including an anode active material and a secondary battery including the anode.

Specifically, the anode active material may be processed by being included in a secondary battery electrode along with a conductive material and a binder through a method commonly practiced in the art.

The conductive material is used to impart conductivity to the electrode, and can be used without particular limitation as long as it does not cause chemical change and has electronic conductivity. Specific examples thereof may include: carbon-based materials such as graphite, carbon black, Super P, acetylene black, Ketjen black, channel black, furnace black, lamp black, summer black, carbon fiber, carbon nanotubes, carbon nanowires, graphene, graphitized mesocarbon microbeads, fullerene, and amorphous carbon; metal powders or metal fibers such as copper, nickel, aluminum, and silver; conductive whiskers such as zinc oxide and potassium titanate; conductive metal oxides such as titanium oxide; or conductive polymers such as polyphenylene derivatives, and one of these alone or mixtures of two or more thereof may be used, but this is only an example and is not limited as long as it is a previously known conductive material.

The binder improves adhesive force between the active material and the conductive material particles or between the active material and the current collector. Specific examples thereof may include polyvinylidene fluoride (PVDF), polyimide (PI), fluoropolyimide (FPI), polyacrylic acid (PAA), polyvinyl alcohol (PVA), carboxymethyl cellulose (CMC), starch, hydroxypropyl cellulose, regenerated cellulose, polyvinylpyrrolidone (PVP), tetrafluoroethylene, polyethylene, polypropylene, polyurethane, ethylene propylene diene monomer (EPDM), sulfonated-EPDM, styrene-butadiene rubber, fluororubber, or copolymers thereof, algin, etc., and one of these alone or mixtures of two or more thereof may be used, but this is only an example and is not limited as long as it is a previously known binder.

The lithium secondary battery may further include: a cathode for a lithium secondary battery; an electrolyte solution for a lithium secondary battery; and a separator.

As a cathode active material in the cathode for a lithium secondary battery, any one or mixtures of two or more selected from LiCoO₂, LiMnO₂, LiNiO₂, LiNi₁₋ₓCoₓO₂, LiNiₓCo_{y}Mn_{z}O₂ (x+y+z=1), LiNiₓCo_{y}Al_{z}O₂ (x+y+z=1), LiNiₓMn_{y}M_{z}O₂ (x+y+z=1, and M is a divalent or trivalent metal or transition metal), LiFePO₄, LiMnPO₄, LiCoPO₄, LiFe₁₋ₓMₓPO₄ (M is a metal or transition metal), LiMn₂O₄, LiMn₂₋ₓMₓO₄ (M is a metal or transition metal), a(Li₂MnO₃)b(LiNIₓCo_{y}Mn_{z}O₂) (a+b=1, x+y+z=1), Li_{1.2}Ni_{0.13}Co_{0.13-x}Mn_{0.54}AlₓO_{2(1-y)}F_{2y} (x and y are mutually independent real numbers from 0 to 0.05), Li_{1.2} Mn_{(0.8-a)}MaO₂ (M is a divalent or trivalent metal or transition metal), Li₂N₁₋ₓMₓO₃ (N is a divalent, trivalent or tetravalent metal or transition metal, and M is a divalent or trivalent metal or transition metal), Li₁₊ₓN_{y-z}M_{z}O₂ (N is Ti or Nb, and M is V, Ti, Mo, or W), Li₄Mn₂₋ₓMₓO₅ (M is a metal or transition metal), LiₓM₂₋ₓO₂ (M is a metal or transition metal such as Ti, Zr, Nb, Mn, or the like), and Li₂O/Li₂Ru₁₋ₓMₓO₃ (M is a metal or transition metal) may be used, but this is only an example and is not limited as long as it is a previously known cathode active material.

In addition, the cathode for a lithium secondary battery may further include a conductive material and a binder, which are the same as the above-described conductive material and binder so that overlapping descriptions are omitted.

The electrolyte solution for a lithium secondary battery may be made of: a lithium salt and a mixed organic solvent containing the same; a polymer matrix; or an all-solid electrolyte.

The lithium salt may be any one or mixtures of two or more selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (provided that x and y are 0 or natural numbers), LiCl, LiI, LiSCN, LiB(C₂O₄)₂, LiF₂BC₂O₄, LiPF₄ (C₂O₄), LiPF₂ (C₂O₄)₂, and LiP(C₂O₄)₃, which is only an example and can be used without particular limitation as long as it is commonly used in the art and thus is not necessarily limited thereto.

The mixed organic solvent is not necessarily limited thereto although it may be any one or mixtures of two or more selected from: a group consisting of cyclic carbonate-based compounds such as ethylene carbonate, propylene carbonate, and vinylene carbonate;
a group consisting of fluorinated cyclic carbonate-based compounds such as fluoroethylene carbonate, difluoroethylene carbonate, and fluoropropylene carbonate;
a group consisting of linear carbonate-based compounds such as dimethyl carbonate, methyl ethyl carbonate, and diethyl carbonate;
a group consisting of fluorinated dimethyl carbonate-based compounds such as fluoromethylmethyl carbonate, difluoromethylmethyl carbonate, trifluoromethylmethyl carbonate, bis(fluoromethyl) carbonate, bis(difluoromethyl) carbonate, bis(trifluoromethyl) carbonate, (fluoromethyl)(difluoromethyl) carbonate, (fluoromethyl)(trifluoromethyl) carbonate, and (difluoromethyl)(trifluoromethyl) carbonate;
a group consisting of fluorine-containing ethylmethyl carbonate-based compounds such as 2-fluoroethylmethyl carbonate, 2,2-difluoroethylmethyl carbonate, 2,2,2-trifluoroethylmethyl carbonate, (2-fluoroethyl)(fluoromethyl) carbonate, (2-fluoroethyl)(difluoromethyl) carbonate, (2-fluoroethyl)(trifluoromethyl) carbonate, (2,2-difluoroethyl)(fluoromethyl) carbonate, (2,2-difluoroethyl)(difluoromethyl) carbonate, (2,2-difluoroethyl)(trifluoromethyl) carbonate, (2,2,2-trifluoroethyl)(fluoromethyl) carbonate, (2,2,2-trifluoroethyl)(difluoromethyl) carbonate, and (2,2,2-trifluoroethyl)(trifluoromethyl) carbonate; and a group consisting of fluorinated diethyl carbonate-based compounds such as 2-fluoroethylethyl carbonate, 2,2-difluoroethylethyl carbonate, 2,2,2-trifluoroethylethyl carbonate, bis(2-fluoroethyl) carbonate, bis(2,2-difluoroethyl) carbonate, bis(2,2,2-trifluoroethyl) carbonate, (2-fluoroethyl)(2,2-difluoroethyl) carbonate, (2-fluoroethyl)(2,2,2-trifluoroethyl) carbonate, and (2,2-difluoroethyl)(2,2,2-trifluoroethyl) carbonate;
a group consisting of fluorinated ester-based compounds such as fluoromethyl acetate, difluoromethyl acetate, trifluoromethyl acetate, 2-fluoroethyl acetate, 2,2-difluoroethyl acetate, 2,2,2-trifluoroethyl acetate, fluoromethyl propionate, difluoromethyl propionate, trifluoromethyl propionate, 2-fluoroethyl propionate, 2,2-difluoroethyl propionate, 2,2,2-trifluoroethyl propionate, 2-fluoroethyl butyrate, 2,2-difluoroethyl butyrate, and 2,2,2-trifluoroethyl butyrate (TFEB);
a group consisting of ether-based compounds such as dimethyl ether, ethylmethyl ether, diethyl ether, propylmethyl ether, propylethyl ether, dipropyl ether, isopropylmethyl ether, isopropylethyl ether, diisopropyl ether, n-butylmethyl ether, n-butylethyl ether, n-butylpropyl ether, n-butylisopropyl ether, n-dibutyl ether, tert-butylmethyl ether, tert-butylethyl ether, tert-butylpropyl ether, tert-butylisopropyl ether, tert-dibutyl ether, ethylene glycol methyl ether, ethylene glycol ethyl ether, ethylene glycol propyl ether, ethylene glycol isopropyl ether, ethylene glycol n-butyl ether, ethylene glycol tert-butyl ether, diethylene glycol ether, propylene glycol methyl ether, propylene glycol ethyl ether, propylene glycol propyl ether, propylene glycol isopropyl ether, propylene glycol n-butyl ether, propylene glycol tert-butyl ether, and dipropylene glycol ether;
a group consisting of fluorinated ethers such as fluoromethyl methyl ether, difluoromethyl methyl ether, trifluoromethyl methyl ether, di(fluoromethyl) ether, difluoromethyl fluoromethyl ether, trifluoromethyl fluoromethyl ether, di(difluoromethyl) ether, trifluoromethyl difluoromethyl ether, di(trifluoromethyl) ether, 1-fluoroethyl methyl ether, 2-fluoroethyl methyl ether, 1,1-difluoroethyl methyl ether, 1,2-difluoroethyl methyl ether, 2,2-difluoroethyl methyl ether, 1,1,1-trifluoroethyl methyl ether, 1,1,2-trifluoroethyl methyl ether, 1,2,2-trifluoroethyl methyl ether, 2,2,2-trifluoroethyl methyl ether, 1,1,1,2-tetrafluoroethyl methyl ether, 1,1,2,2-tetrafluoroethyl methyl ether, 1,2,2,2-tetrafluoroethyl methyl ether, 1,1,1,2,2-pentafluoroethyl methyl ether, 1,1,2,2,2-pentafluoroethyl methyl ether, hexafluoroethyl methyl ether, 1-fluoroethyl fluoromethyl ether, 2-fluoroethyl fluoromethyl ether, 1,1-difluoroethyl fluoromethyl ether, 1,2-difluoroethyl fluoromethyl ether, 2,2-difluoroethyl fluoromethyl ether, 1,1,1-trifluoroethyl fluoromethyl ether, 1,1,2-trifluoroethyl fluoromethyl ether, 1,2,2-trifluoroethyl fluoromethyl ether, 2,2,2-trifluoroethyl fluoromethyl ether, 1,1,1,2-tetrafluoroethyl fluoromethyl ether, 1,1,2,2-tetrafluoroethyl fluoromethyl ether, 1,2,2,2-tetrafluoroethyl fluoromethyl ether, 1,1,1,2,2-pentafluoroethyl fluoromethyl ether, 1,1,2,2,2-pentafluoroethyl fluoromethyl ether, hexafluoroethyl fluoromethyl ether, 1-fluoroethyl difluoromethyl ether, 2-fluoroethyl difluoromethyl ether, 1,1-difluoroethyl difluoromethyl ether, 1,2-difluoroethyl difluoromethyl ether, 2,2-difluoroethyl difluoromethyl ether, 1,1,1-trifluoroethyl difluoromethyl ether, 1,1,2-trifluoroethyl difluoromethyl ether, 1,2,2-trifluoroethyl difluoromethyl ether, 2,2,2-trifluoroethyl difluoromethyl ether, 1,1,1,2-tetrafluoroethyl difluoromethyl ether, 1,1,2,2-tetrafluoroethyl difluoromethyl ether, 1,2,2,2-tetrafluoroethyl difluoromethyl ether, 1,1,1,2,2-pentafluoroethyl difluoromethyl ether, 1,1,2,2,2-pentafluoroethyl difluoromethyl ether, hexafluoroethyl difluoromethyl ether, 1-fluoroethyl trifluoromethyl ether, 2-fluoroethyl trifluoromethyl ether, 1,1-difluoroethyl trifluoromethyl ether, 1,2-difluoroethyl trifluoromethyl ether, 2,2-difluoroethyl trifluoromethyl ether, 1,1,1-trifluoroethyl trifluoromethyl ether, 1,1,2-trifluoroethyl trifluoromethyl ether, 1,2,2-trifluoroethyl trifluoromethyl ether, 2,2,2-trifluoroethyl trifluoromethyl ether, 1,1,1,2-tetrafluoroethyl trifluoromethyl ether, 1,1,2,2-tetrafluoroethyl trifluoromethyl ether, 1,2,2,2-tetrafluoroethyl trifluoromethyl ether, 1,1,1,2,2-pentafluoroethyl trifluoromethyl ether, 1,1,2,2,2-pentafluoroethyl trifluoromethyl ether, hexafluoroethyl trifluoromethyl ether, 1-fluoroethyl ethyl ether, 2-fluoroethyl ethyl ether, 1,1-difluoroethyl ethyl ether, 1,2-difluoroethyl ethyl ether, 2,2-difluoroethyl ethyl ether, 1,1,1-trifluoroethyl ethyl ether, 1,1,2-trifluoroethyl ethyl ether, 1,2,2-trifluoroethyl ethyl ether, 2,2,2-trifluoroethyl ethyl ether, 1,1,1,2-tetrafluoroethyl ethyl ether, 1,1,2,2-tetrafluoroethyl ethyl ether, 1,2,2,2-tetrafluoroethyl ethyl ether, 1,1,1,2,2-pentafluoroethyl ethyl ether, 1,1,2,2,2-pentafluoroethyl ethyl ether, hexafluoroethyl ethyl ether, 1-fluoroethyl ether, 2-fluoroethyl 1-fluoroethyl ether, 1,1-difluoroethyl 1-fluoroethyl ether, 1,2-difluoroethyl 1-fluoroethyl ether, 2,2-difluoroethyl 1-fluoroethyl ether, 1,1,1-trifluoroethyl 1-fluoroethyl ether, 1,1,2-trifluoroethyl 1-fluoroethyl ether, 1,2,2-trifluoroethyl 1-fluoroethyl ether, 2,2,2-trifluoroethyl 1-fluoroethyl ether, 1,1,1,2-tetrafluoroethyl 1-fluoroethyl ether, 1,1,2,2-tetrafluoroethyl 1-fluoroethyl ether, 1,2,2,2-tetrafluoroethyl 1-fluoroethyl ether, 1,1,1,2,2-pentafluoroethyl 1-fluoroethyl ether, 1,1,2,2,2-pentafluoroethyl 1-fluoroethyl ether, hexafluoroethyl 1-fluoroethyl ether, 1-fluoroethyl 2-fluoroethyl ether, 2-fluoroethyl ether, 1,1-difluoroethyl 2-fluoroethyl ether, 1,2-difluoroethyl 2-fluoroethyl ether, 2,2-difluoroethyl 2-fluoroethyl ether, 1,1,1-trifluoroethyl 2-fluoroethyl ether, 1,1,2-trifluoroethyl 2-fluoroethyl ether, 1,2,2-trifluoroethyl 2-fluoroethyl ether, 2,2,2-trifluoroethyl 2-fluoroethyl ether, 1,1,1,2-tetrafluoroethyl 2-fluoroethyl ether, 1,1,2,2-tetrafluoroethyl 2-fluoroethyl ether, 1,2,2,2-tetrafluoroethyl 2-fluoroethyl ether, 1,1,1,2,2-pentafluoroethyl 2-fluoroethyl ether, 1,1,2,2,2-pentafluoroethyl 2-fluoroethyl ether, hexafluoroethyl 2-fluoroethyl ether, 1-fluoroethyl 1,2-difluoroethyl ether, 2-fluoroethyl 1,2-difluoroethyl ether, 1,1-difluoroethyl 1,2-difluoroethyl ether, di(1,2-difluoroethyl) ether, 2,2-difluoroethyl 1,2-difluoroethyl ether, 1,1,1-trifluoroethyl 1,2-difluoroethyl ether, 1,1,2-trifluoroethyl 1,2-difluoroethyl ether, 1,2,2-trifluoroethyl 1,2-difluoroethyl ether, 2,2,2-trifluoroethyl 1,2-difluoroethyl ether, 1,1,1,2-tetrafluoroethyl 1,2-difluoroethyl ether, 1,1,2,2-tetrafluoroethyl 1,2-difluoroethyl ether, 1,2,2,2-tetrafluoroethyl 1,2-difluoroethyl ether, 1,1,1,2,2-pentafluoroethyl 1,2-difluoroethyl ether, 1,1,2,2,2-pentafluoroethyl 1,2-difluoroethyl ether, hexafluoroethyl 1,2-difluoroethyl ether, 1,1-difluoroethyl 2,2-difluoroethyl ether, 1,2-difluoroethyl 2,2-difluoroethyl ether, di(2,2-difluoroethyl) ether, 1,1,1-trifluoroethyl 2,2-difluoroethyl ether, 1,1,2-trifluoroethyl 2,2-difluoroethyl ether, 1,2,2-trifluoroethyl 2,2-difluoroethyl ether, 2,2,2-trifluoroethyl 2,2-difluoroethyl ether, 1,1,1,2-tetrafluoroethyl 2,2-difluoroethyl ether, 1,1,2,2-tetrafluoroethyl 2,2-difluoroethyl ether, 1,2,2,2-tetrafluoroethyl 2,2-difluoroethyl ether, 1,1,1,2,2-pentafluoroethyl 2,2-difluoroethyl ether, 1,1,2,2,2-pentafluoroethyl 2,2-difluoroethyl ether, hexafluoroethyl 2,2-difluoroethyl ether, 1,1-difluoroethyl 1,1,1-trifluoroethyl ether, 1,2-difluoroethyl 1,1,1-trifluoroethyl ether, 2,2-difluoroethyl 1,1,1-trifluoroethyl ether, di(1,1,1-trifluoroethyl) ether, 1,1,2-trifluoroethyl 1,1,1-trifluoroethyl ether, 1,2,2-trifluoroethyl 1,1,1-trifluoroethyl ether, 2,2,2-trifluoroethyl 1,1,1-trifluoroethyl ether, 1,1,1,2-tetrafluoroethyl 1,1,1-trifluoroethyl ether, 1,1,2,2-tetrafluoroethyl 1,1,1-trifluoroethyl ether, 1,2,2,2-tetrafluoroethyl 1,1,1-trifluoroethyl ether, 1,1,1,2,2-pentafluoroethyl 1,1,1-trifluoroethyl ether, 1,1,2,2,2-pentafluoroethyl 1,1,1-trifluoroethyl ether, hexafluoroethyl 1,1,1-trifluoroethyl ether, 1,1-difluoroethyl 1,1,2-trifluoroethyl ether, 1,2-difluoroethyl 1,1,2-trifluoroethyl ether, 2,2-difluoroethyl 1,1,2-trifluoroethyl ether, 1,1,1-trifluoroethyl 1,1,2-trifluoroethyl ether, 1,1,2-trifluoroethyl ether, 1,2,2-trifluoroethyl 1,1,2-trifluoroethyl ether, 2,2,2-trifluoroethyl 1,1,2-trifluoroethyl ether, 1,1,1,2-tetrafluoroethyl 1,1,2-trifluoroethyl ether, 1,1,2,2-tetrafluoroethyl 1,1,2-trifluoroethyl ether, 1,2,2,2-tetrafluoroethyl 1,1,2-trifluoroethyl ether, 1,1,1,2,2-pentafluoroethyl 1,1,2-trifluoroethyl ether, 1,1,2,2,2-pentafluoroethyl 1,1,2-trifluoroethyl ether, hexafluoroethyl 1,1,2-trifluoroethyl ether, 1,1-difluoroethyl 1,2,2-trifluoroethyl ether, 1,2-difluoroethyl 1,2,2-trifluoroethyl ether, 2,2-difluoroethyl 1,2,2-trifluoroethyl ether, 1,1,1-trifluoroethyl 1,2,2-trifluoroethyl ether, 1,1,2-trifluoroethyl 1,2,2-trifluoroethyl ether, di(1,2,2-trifluoroethyl) ether, 2,2,2-trifluoroethyl 1,2,2-trifluoroethyl ether, 1,1,1,2-tetrafluoroethyl 1,2,2-trifluoroethyl ether, 1,1,2,2-tetrafluoroethyl 1,2,2-trifluoroethyl ether, 1,2,2,2-tetrafluoroethyl 1,2,2-trifluoroethyl ether, 1,1,1,2,2-pentafluoroethyl 1,2,2-trifluoroethyl ether, 1,1,2,2,2-pentafluoroethyl 1,2,2-trifluoroethyl ether, hexafluoroethyl 1,2,2-trifluoroethyl ether, 1,1-difluoroethyl 2,2,2-trifluoroethyl ether, 1,2-difluoroethyl 2,2,2-trifluoroethyl ether, 2,2-difluoroethyl 2,2,2-trifluoroethyl ether, 1,1,1-trifluoroethyl 2,2,2-trifluoroethyl ether, 1,1,2-trifluoroethyl 2,2,2-trifluoroethyl ether, 1,2,2-trifluoroethyl 2,2,2-trifluoroethyl ether, di(2,2,2-trifluoroethyl) ether, 1,1,1,2-tetrafluoroethyl 2,2,2-trifluoroethyl ether, 1,1,2,2-tetrafluoroethyl 2,2,2-trifluoroethyl ether, 1,2,2,2-tetrafluoroethyl 2,2,2-trifluoroethyl ether, 1,1,1,2,2-pentafluoroethyl 2,2,2-trifluoroethyl ether, 1,1,2,2,2-pentafluoroethyl 2,2,2-trifluoroethyl ether, hexafluoroethyl 2,2,2-trifluoroethyl ether, 1,1-difluoroethyl 1,1,1,2-tetrafluoroethyl ether, 1,2-difluoroethyl 1,1,1,2-tetrafluoroethyl ether, 2,2-difluoroethyl 1,1,1,2-tetrafluoroethyl ether, 1,1,1-trifluoroethyl 1,1,1,2-tetrafluoroethyl ether, 1,1,2-trifluoroethyl 1,1,1,2-tetrafluoroethyl ether, 1,2,2-trifluoroethyl 1,1,1,2-tetrafluoroethyl ether, 2,2,2-trifluoroethyl 1,1,1,2-tetrafluoroethyl ether, di(1,1,1,2-tetrafluoroethyl) ether, 1,1,2,2-tetrafluoroethyl 1,1,1,2-tetrafluoroethyl ether, 1,2,2,2-tetrafluoroethyl 1,1,1,2-tetrafluoroethyl ether, 1,1,1,2,2-pentafluoroethyl 1,1,1,2-tetrafluoroethyl ether, 1,1,2,2,2-pentafluoroethyl 1,1,1,2-tetrafluoroethyl ether, hexafluoroethyl 1,1,1,2-tetrafluoroethyl ether, 1,1-difluoroethyl 1,1,2,2-tetrafluoroethyl ether, 1,2-difluoroethyl 1,1,2,2-tetrafluoroethyl ether, 2,2-difluoroethyl 1,1,2,2-tetrafluoroethyl ether, 1,1,1-trifluoroethyl 1,1,2,2-tetrafluoroethyl ether, 1,1,2-trifluoroethyl 1,1,2,2-tetrafluoroethyl ether, 1,2,2-trifluoroethyl 1,1,2,2-tetrafluoroethyl ether, 2,2,2-trifluoroethyl 1,1,2,2-tetrafluoroethyl ether, 1,1,1,2-tetrafluoroethyl 1,1,2,2-tetrafluoroethyl ether, di(1,1,2,2-tetrafluoroethyl) ether, 1,2,2,2-tetrafluoroethyl 1,1,2,2-tetrafluoroethyl ether, 1,1,1,2,2-pentafluoroethyl 1,1,2,2-tetrafluoroethyl ether, 1,1,2,2,2-pentafluoroethyl 1,1,2,2-tetrafluoroethyl ether, hexafluoroethyl 1,1,2,2-tetrafluoroethyl ether, 1,1-difluoroethyl 1,2,2,2-tetrafluoroethyl ether, 1,2-difluoroethyl 1,2,2,2-tetrafluoroethyl ether, 2,2-difluoroethyl 1,2,2,2-tetrafluoroethyl ether, 1,1,1-trifluoroethyl 1,2,2,2-tetrafluoroethyl ether, 1,1,2-trifluoroethyl 1,2,2,2-tetrafluoroethyl ether, 1,2,2-trifluoroethyl 1,2,2,2-tetrafluoroethyl ether, 2,2,2-trifluoroethyl 1,2,2,2-tetrafluoroethyl ether, 1,1,1,2-tetrafluoroethyl 1,2,2,2-tetrafluoroethyl ether, 1,1,2,2-tetrafluoroethyl 1,2,2,2-tetrafluoroethyl ether, di(1,2,2,2-tetrafluoroethyl) ether, 1,1,1,2,2-pentafluoroethyl 1,2,2,2-tetrafluoroethyl ether, 1,1,2,2,2-pentafluoroethyl 1,2,2,2-tetrafluoroethyl ether, hexafluoroethyl 1,2,2,2-tetrafluoroethyl ether, 1,1-difluoroethyl 1,1,1,2,2-pentafluoroethyl ether, 1,2-difluoroethyl 1,1,1,2,2-pentafluoroethyl ether, 2,2-difluoroethyl 1,1,1,2,2-pentafluoroethyl ether, 1,1,1-trifluoroethyl 1,1,1,2,2-pentafluoroethyl ether, 1,1,2-trifluoroethyl 1,1,1,2,2-pentafluoroethyl ether, 1,2,2-trifluoroethyl 1,1,1,2,2-pentafluoroethyl ether, 2,2,2-trifluoroethyl 1,1,1,2,2-pentafluoroethyl ether, 1,1,1,2-tetrafluoroethyl 1,1,1,2,2-pentafluoroethyl ether, 1,1,2,2-tetrafluoroethyl 1,1,1,2,2-pentafluoroethyl ether, 1,2,2,2-tetrafluoroethyl 1,1,1,2,2-pentafluoroethyl ether, di(1,1,1,2,2-pentafluoroethyl) ether, 1,1,2,2,2-pentafluoroethyl 1,1,1,2,2-pentafluoroethyl ether, hexafluoroethyl 1,1,1,2,2-pentafluoroethyl ether, 1,1-difluoroethyl 1,1,2,2,2-pentafluoroethyl ether, 1,2-difluoroethyl 1,1,2,2,2-pentafluoroethyl ether, 2,2-difluoroethyl 1,1,2,2,2-pentafluoroethyl ether, 1,1,1-trifluoroethyl 1,1,2,2,2-pentafluoroethyl ether, 1,1,2-trifluoroethyl 1,1,2,2,2-pentafluoroethyl ether, 1,2,2-trifluoroethyl 1,1,2,2,2-pentafluoroethyl ether, 2,2,2-trifluoroethyl 1,1,2,2,2-pentafluoroethyl ether, 1,1,1,2-tetrafluoroethyl 1,1,2,2,2-pentafluoroethyl ether, 1,1,2,2-tetrafluoroethyl 1,1,2,2,2-pentafluoroethyl ether, 1,2,2,2-tetrafluoroethyl 1,1,2,2,2-pentafluoroethyl ether, 1,1,1,2,2-pentafluoroethyl 1,1,2,2,2-pentafluoroethyl ether, di(1,1,2,2,2-penta fluoroethyl) ether, hexafluoroethyl 1,1,1,2,2-pentafluoroethyl ether, and dihexafluoroethyl ether; and
a group consisting of sulfate-based compounds such as bis(fluoromethyl) sulfate, bis(2-fluoroethyl)sulfate, bis(3-fluoropropyl) sulfate, bis(difluoromethyl) sulfate, bis(2,2-difluoroethyl) sulfate, bis(3,3-difluoropropyl) sulfate, bis(trifluoromethyl) sulfate, bis(2,2,2-trifluoroethyl) sulfate, bis(3,3,3-trifluoropropyl) sulfate, methyl(fluoromethyl) sulfate, methyl(2-fluoroethyl) sulfate, methyl(3-fluoropropyl) sulfate, methyl(difluoromethyl) sulfate, methyl(2,2-difluoroethyl) sulfate, methyl(3,3-difluoropropyl) sulfate, methyl(trifluoromethyl) sulfate, methyl(2,2,2-trifluoroethyl) sulfate, methyl(3,3,3-trifluoropropyl) sulfate, ethyl(fluoromethyl) sulfate, ethyl(2-fluoroethyl) sulfate, ethyl(3-fluoropropyl) sulfate, ethyl(difluoromethyl) sulfate, ethyl(2,2-difluoroethyl) sulfate, ethyl(3,3-difluoropropyl) sulfate, ethyl(trifluoromethyl) sulfate, ethyl(2,2,2-trifluoroethyl) sulfate, ethyl(3,3,3-trifluoropropyl) sulfate, propyl(fluoromethyl) sulfate, propyl(2-fluoroethyl) sulfate, propyl(3-fluoropropyl) sulfate, propyl(difluoromethyl) sulfate, propyl(2,2-difluoroethyl) sulfate, propyl(3,3-difluoropropyl) sulfate, propyl(trifluoromethyl) sulfate, propyl(2,2,2-trifluoroethyl) sulfate, prop yl(3,3,3-trifluoropropyl) sulfate, (fluoromethyl)(2-fluoroethyl) sulfate, (fluoromethyl)(3-fluoropropyl) sulfate, (fluoromethyl)(difluoromethyl) sulfate, (fluoromethyl)(2,2-difluoroethyl) sulfate, (fluoromethyl)(3,3-difluoropropyl) sulfate, (fluoromethyl)(trifluoromethyl) sulfate, (fluoromethyl)(2,2,2-trifluoroethyl) sulfate, (fluoromethyl)(3,3,3-trifluoropropyl) sulfate, (2-fluoroethyl)(3-fluoroprop yl) sulfate, (2-fluoroethyl)(difluoromethyl) sulfate, (2-fluoroethyl)(2,2-difluoroethyl) sulfate, (2-fluoroethyl)(3,3-difluoropropyl) sulfate, (2-fluoroethyl)(trifluoromethyl) sulfate, (2-fluoroethyl)(2,2,2-trifluoroethyl) sulfate, (2-fluoroethyl)(3,3,3-trifluoroprop yl) sulfate, (3-fluoropropyl)(difluoromethyl) sulfate, (3-fluoropropyl)(2,2-difluoroethyl) sulfate, (3-fluoropropyl)(3,3-difluoropropyl) sulfate, (3-fluoropropyl)(trifluoromethyl) sulfate, (3-fluoropropyl)(2,2,2-trifluoroethyl) sulfate, (3-fluoropropyl)(3,3,3-trifluoropropyl) sulfate, (difluoromethyl)(2,2-difluoroethyl) sulfate, (difluoromethyl)(3,3-difluoropropyl) sulfate, (difluoromethyl)(trifluoromethyl) sulfate, (difluoromethyl)(2,2,2-trifluoroethyl) sulfate, (difluoromethyl)(3,3,3-trifluoropropyl) sulfate, (2,2-difluoroethyl)(3,3-difluoroprop yl) sulfate, (2,2-difluoroethyl)(trifluoromethyl) sulfate, (2,2-difluoroethyl)(2,2,2-trifluoroethyl) sulfate, (2,2-difluoroethyl)(3,3,3-trifluoroprop yl) sulfate, (3,3-difluoropropyl)trifluoromethyl) sulfate, (3,3-difluoropropyl)(2,2,2-trifluoroethyl) sulfate, and (3,3-difluoropropyl)(3,3,3-trifluoropropyl) sulfate.

The mixed organic solvent may further contain an additive.

The additive may serve to assist in the formation of a cathode-electrolyte interface (CEI). Specifically, it may be any one or two or more selected from a group consisting of boron series such as trimethyl boroxine (TMB), triethyl boroxine, trimethyl borate, triethyl borate (TEB), tris(trimethylsilyl) borate (TMSB), lithium trifluoro(perfluoro-tert-butyloxyl) borate (LiTPBOB), and lithium difluoro(oxalato) borate (LiDFOB); a group consisting of sulfur series such as 4,4-bi(1,3,2-dioxathiolane)_{2,2}-dioxide (BDTD) and 2-(2,2,2-trifluoroethoxy)-1,3,2-dioxaphospholane-2-oxide (TFEOP); a group consisting of fluorinated series which include methyl 2,2,2-trifluoroethyl carbonate (FEMC), methyl difluoroacetate (DFMAc), ethyl difluoroacetate (DFEAc), etc. or are added in combination with fluoroethylene carbonate (FEC); and a group consisting of lithium salts such as LiPO₂F₂, but is not necessarily limited thereto, and is not particularly limited as long as it is a previously known additive that assists in the formation of CEI.

The additive may serve to directly form or assist a solid-electrolyte interface (SEI). Specifically, it may be any one or two or more selected from a group consisting of cyclic compounds such as fluoroethylene carbonate (FEC), vinylene carbonate (VC), vinyl ethylene carbonate (VEC), allyl ethyl carbonate, vinyl acetate, divinyl adipate, acrylic acid nitrile, 2-vinyl pyridine, γ-butyrolactone (GBL), methylphenyl carbonate, succinic imide, maleic anhydride, methyl chloroformate, methyl cinnamate, and furan derivatives having double bonds; a group consisting of phosphonate compounds; a group consisting of vinyl-containing silane compounds; a group consisting of nitrate and nitrite compounds; and a group consisting of lithium salts such as LiPO₂F₂, but is not necessarily limited thereto, and is not particularly limited as long as it is a previously known additive that forms or assists in the formation of SEI.

The additive may serve to remove active materials such as HF and PF₅. Specifically, it may be any one or two or more selected from a group having an isocyanate (N═C═O) functional group such as p-toluene sulfonyl isocyanate (PTSI); a group consisting of pyrrolidinones such as 1-methyl-2-pyrrolidinone; a group consisting of silane derivatives having a Si—O structure, such as dimethoxy dimethyl silane (DODSi) and diphenyl dimethoxy silane (DPDMS); a group consisting of phosphoramides such as hexamethyl phosphoramide; a group consisting of phosphites such as tris(2,2,2-trifluoroethyl) phosphite and tris(trimethylsilyl) phosphite (TMSPi); and a group consisting of phosphonites such as diethyl phenyl phosphonite (DEPP), but is not necessarily limited thereto, and is not particularly limited as long as it is a previously known additive that removes active materials.

The additive may serve to prevent overcharging. Specifically, it may be any one or two or more selected from a group consisting of organic compounds such as metallocenes, tetracyano ethylene, tetramethyl phenylene diamine, dihydrophenazine, bipyridyl carbonates, biphenyl carbonates, and 2,7-diacetyl thianthrene, phenothiazine; a group consisting of lithium salts such as lithium fluorododecaborates (Li₂B₁₂FₓH₁₂₋ₓ) and lithium bis(oxalato)borate (LiBOB); and a group consisting of aromatic compounds such as xylene, cyclohexyl benzene, hexaethyl benzene, biphenyl, 2,2-diphenyl propane, 2,5-di-tert-butyl-1,4-dimethoxy benzene, phenyl-tert-butyl carbonate, anisole, difluoroanisole, and thiophene-3-acetonitrile, but is not necessarily limited thereto, and is not particularly limited as long as it is a previously known additive that prevents overcharging.

The additive may be added to increase flame retardancy of the secondary battery. Specifically, it may be any one or two or more selected from a group consisting of alkyl phosphates such as trimethyl phosphate and triethyl phosphate; a group consisting of halogenated phosphates such as tris(2,2,2-trifluoroethyl) phosphate; a group consisting of phosphazenes such as hexamethoxy cyclophosphazene; and a group consisting of fluorinated ethers and fluorinated carbonates such as methyl nonafluorobutyl ether (MFE) and fluoropropylene carbonate, but is not necessarily limited thereto, and is not particularly limited as long as it is a previously known additive that increases flame retardancy.

The additive may be added for uniform reduction deposition of lithium. Specifically, it may be any one or two or more selected from tetrahydrofuran, 2-methyltetrahydrofuran, thiophene, 2-methylthiophene, nitromethane, tetraalkylammonium chloride, cetyltrimethylammonium chloride, lithium perfluorooctane sulfonate, tetraethylammonium perfluorooctane sulfonate, perfluoropolyethers, AlI₃, SnI₂, etc.

The additive may be added to help a solvation phenomenon of ions. Specifically, it may be any one or two or more selected from 12-crown-4 and its derivatives, tris(pentafluorophenyl)borane, cyclic aza-ether compounds, borole compounds, etc.

The additive may be added to prevent corrosion of an aluminum current collector. Specifically, it may include lithium salt compounds having chemical formulas of LiN(FSO₂)₂ and LiN(SO₂CₙF₂ₙ₊₁)₂ (n=2 to 4).

The content of the additive may be adjusted within a range of 0.01 to 10% by weight depending on desired physical properties.

The concentration of an electrolyte composed of a mixed organic solvent containing the lithium salts may be adjusted to a level commonly used in the art, and specifically for example, the concentration of the lithium salt may be 0.1 to 60 M, more preferably 1.0 to 1.2 M.

The electrolyte may include the polymer electrolyte matrix to improve mechanical properties or high-temperature stability of the battery. Specifically, it may be any one or mixtures of two or more selected from the group consisting of polymers such as polyacrylate, polymethacrylate, polyvinylidene fluoride (PVDF), polyhexafluoropropylene (PHFP), polyethylene oxide (PEO), polypropylene oxide (PPO), polydimethyl siloxane, polyacrylonitrile, polyvinyl chloride (PVC) and PEGDME, and copolymers mixed therewith, and is not limited as long as it is a previously known polymer material for lithium secondary batteries.

In addition, the electrolyte solution may be an electrolyte solution for high-speed charging. The electrolyte solution for high-speed charging is an electrolyte solution in which two different types of solvents are mixed to be used, and which, when excessive nickel-containing nickel-cobalt-manganese (NCM) is used as a cathode active material, not only enables rapid charging, but also has no or less risk of fire and explosion, thereby having excellent stability, and the lithium secondary battery including the electrolyte solution of the present invention can promote excellent stability, fast charging, high performance, long lifespan, and high energy density.

Specifically, the electrolyte solution for high-speed charging of the lithium secondary battery according to one embodiment of the present invention may include: a lithium salt; a first solvent containing a compound represented by the following Chemical Formula 1; and a second solvent containing a compound represented by the flowing Chemical Formula 2:

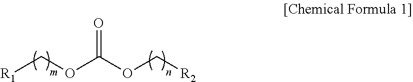

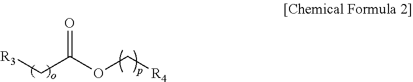

where,
n, m, o, and p are the same as or different from each other, and are each independently an integer of 0 to 5,
R₁ to R₄ are the same as or different from each other, and may be each independently selected from the group consisting of hydrogen, a substituted or unsubstituted alkyl group having 1 to 10 carbon atoms, a substituted or unsubstituted alkenyl group having 2 to 10 carbon atoms, and a substituted or unsubstituted alkynyl group having 2 to 10 carbon atoms.

When a mixed solvent of a first solvent containing the compound represented by Chemical Formula 1 above and a second solvent containing the compound represented by Chemical Formula 2 above is applied to the electrolyte solution so that it is included in a lithium secondary battery as a non-aqueous electrolyte solution, the lithium secondary battery can be provided as a lithium secondary battery that enables high-speed charging three times or more faster than when using a conventional electrolyte solution and exhibits excellent battery performance.

In addition, the electrolyte solution containing the first solvent and the second solvent may have flame-retardant or non-flammable non-ignitability, and since accidents such as catching fire or exploding a lithium secondary battery in a disaster such as a fire or the like may be prevented through this, safety can be greatly improved.

More specifically, the first solvent may contain a linear carbonate-based compound represented by the following Chemical Formula 1:

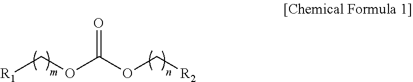

where,
n and m are the same as or different from each other, and are each independently an integer of 0 to 5,
R₁ and R₂ are the same as or different from each other, and may be each independently selected from the group consisting of hydrogen, a substituted or unsubstituted alkyl group having 1 to 10 carbon atoms, a substituted or unsubstituted alkenyl group having 2 to 10 carbon atoms, and a substituted or unsubstituted alkynyl group having 2 to 10 carbon atoms.

As a specific example, the compound represented by Chemical Formula 1 above may be selected from the group consisting of ethyl methyl carbonate (EMC), dimethyl carbonate (DMC), diethyl carbonate (DEC), 2,2,2-trifluoroethyl methyl carbonate (FEMC), di-2,2,2-trifluoroethyl carbonate (DFDEC), and mixtures thereof, but any linear carbonate-based compound enabling high-speed charging of a lithium secondary battery may be used without limitation.

The second solvent may contain a linear ester-based compound represented by the following Chemical Formula 2:

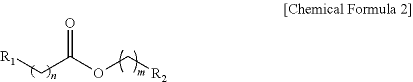

where,
n and m are the same as or different from each other, and are each independently an integer of 0 to 5,
R₁ and R₂ are the same as or different from each other, and may be each independently hydrogen or a substituted or unsubstituted alkyl group having 1 to 10 carbon atoms.

As a specific example, the compound represented by Chemical Formula 1 above may be selected from the group consisting of fluoromethyl acetate, difluoromethyl acetate, trifluoromethyl acetate, 2-fluoroethyl acetate, 2,2-difluoroethyl acetate, 2,2,2-trifluoroethyl acetate, fluoromethyl propionate, difluoromethyl propionate, trifluoromethyl propionate, 2-fluoroethyl propionate, 2,2-difluoroethyl propionate, 2,2,2-trifluoroethyl propionate, 2-fluoroethyl butyrate, 2,2-difluoroethyl butyrate, 2,2,2-trifluoroethyl butyrate (TFEB), and mixtures thereof, and is not limited to the examples of the compound, and any linear ester-based compound enabling high-speed charging of a lithium secondary battery may be used without limitation.

In addition, a mixed solvent of a first solvent containing the compound represented by Chemical Formula 1 above and a second solvent containing the compound represented by Chemical Formula 2 above is applied to the electrolyte solution so that the non-aqueous electrolyte solution may have flame-retardant or non-flammable non-ignitability, and since accidents such as fire catching on a lithium secondary battery or explosion thereof in a disaster such as a fire or the like may be prevented through this, safety can be greatly improved.

Specifically, the ignition properties of the electrolyte solution may be defined as nonflammable when SET<6, flame retardant when 6<SET<20, and flammable when SET≥20 depending on the self-extinguishing time (SET (unit: sec/g)), and the flame-retardant or non-flammable electrolyte solution according to one embodiment of the present invention may have a self-extinguishing time of less than 20 seconds/g, more preferably less than 6 seconds/g, and more preferably less than 3 seconds/g. At this time, the lower limit of the self-extinguishing time may be 0 sec/g. Through the self-extinguishing time characteristics as described above, the electrolyte solution of the present invention may exhibit flame-retardant or non-flammable ignition properties.

In addition, unlike conventional methods in which battery performance is reduced if safety is improved, it is possible to secure non-ignitability and prevent degradation of battery performance at the same time through a combination of an electrolyte solution containing the mixed solvent of the first solvent and the second solvent and an excessive nickel-containing NCM cathode active material represented by Chemical Formula 3 as will be described later.

The volume ratio of the first solvent to the second solvent may be 99:1 to 1:99, 90:10 to 10:90, 90:10 to 20:80, 90:10 to 30:70, or 80:20 to 40:60. As the solvents are mixed at the volume ratios as described above and used, they not only can be provided as an electrolyte solution capable of enabling high-speed charging, but also can secure non-ignitability of less than 20 seconds/g at the same time.

The electrolyte solution for high-speed charging includes a lithium salt, and the lithium salt may be selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (provided that x and y are 0 or natural numbers), LiCl, LiI, LiSCN, LiB(C₂O₄)₂, LiF₂BC₂O₄, LiPF₄ (C₂O₄), LiPF₂(C₂O₄)₂, LiPO₂F₂, LiP(C₂O₄)₃, and mixtures thereof, but it may be used without particular limitation as long as it is commonly used in the art.

The concentration of the lithium salt in the electrolyte solution for high-speed charging may be 0.1 to 60 M, more preferably 0.5 to 10 M, and further more preferably 1.0 to 1.2 M, but is not limited to the above-described range, and any concentration range of the lithium salt that exhibits flame retardancy or non-flammability and can exhibit excellent stability can be used.

The electrolyte solution for high-speed charging may further contain an additive, and the additive may be used without particular limitation as long as it is commonly used in the art.

The electrolyte solution composition may further include an additive selected from the group consisting of vinylene carbonate (VC), vinylene ethylene carbonate (VEC), propane sultone (PS), fluoroethylene carbonate (FEC), ethylene sulfate (ES), pentaerythritol disulfate (PDS), lithium difluorophosphate (LiPO₂F₂), lithium oxalyldifluoroborate (LiODFB), lithium bis(oxalato)borate (LiBOB), and mixtures thereof, preferably an additive selected from the group consisting of vinylene carbonate (VC), fluoroethylene carbonate (FEC), and a mixture thereof, but is not necessarily limited to the above examples.

The addition amount of the additive in the electrolyte solution may also be adjusted to a level commonly used in the art, and specifically, for example, the addition amount of the additive may be 0.1 to 13% by weight, 0.2 to 5% by weight, or 0.1 to 2% by weight of the total weight of the electrolyte solution. As the additive is included within the above range, battery performance by high-speed charging may be improved.

The polymer matrix may include crosslinking units for crosslinking each other.

The all-solid electrolyte is a composite of the polymer matrix and the lithium salt, and is a form in which these are mixed, and the components constituting them are the same as those of the above-described polymer matrix and the lithium salt so that overlapping descriptions are omitted.

The separator may be a porous polymer film that is any one of polyethylene and polypropylene; or a porous polymer film coated with a ceramic material.

The lithium secondary battery may be manufactured in various shapes such as a prismatic shape, a cylindrical shape, a coin shape, or a pouch shape.

The lithium secondary battery may be a lithium ion secondary battery, a lithium polymer secondary battery, or a lithium all-solid secondary battery, and may be used in wearable electronic devices, power tools, and energy storage systems (ESSs). In particular, it is suitable for use in electric vehicles (EVs) with high value of high-speed charging technology, portable electronic devices such as smartphones, electric two-wheeled vehicles such as electric bicycles and electric scooters, drones, electric airplanes, or electric golf carts.

Hereinafter, an anode active material according to the present invention and a high-capacity secondary battery for high-speed charging/discharging including the same will be described in more detail through Examples. However, the following Examples are only one reference for explaining the present invention in detail, but the present invention is not limited thereto, and may be implemented in various forms.

Further, unless defined otherwise, all technical and scientific terms have the same meaning as commonly understood by one of ordinary skill in the art to which the present invention belongs. The terms used in the description in the present application are merely to effectively describe specific embodiments and are not intended to limit the present invention. In addition, the unit of additives not specifically described in the specification may be % by weight.

### EXPERIMENTAL EXAMPLE

1) Charge and Discharge Test 1:

Manufactured were 2032 coin-type lithium half-cells composed of silicon oxide (SiO)-high speed charging-type graphite composite electrodes and high speed charging-type graphite electrodes prepared in Examples 1 to 4 and Comparative Example 1, a lithium metal electrode, a 1.0 M LiPF₆/EC:EMC (volume ratio of 3:7) electrolyte solution including 10% by weight of a fluoroethylene carbonate (FEC) additive based on the total weight of the electrolyte solution, and a separator.

At room temperature (25° C.), low-speed (0.1 C, 10 hours required for charging) charge and discharge cycles were performed twice in the voltage range of 0.01 to 1.5 V. The cycles included performing charging up to 0.01 V with constant current (CC) of 0.1 C-rate, then performing charging with constant voltage (CV) until the current reached 0.005 C, and performing discharging to 1.5 V under CC conditions. Thereafter, the charge and discharge cycles were performed 100 times to a high speed (1 C, 1 hour required for charging) at room temperature (25° C.) in a voltage range of 0.01 to 1.5 V to measure the discharge capacity per weight (specific gravimetric capacity) and the initial Coulombic efficiency under 0.1 C formation conditions, and the capacity retention rate for the 100th cycle was calculated according to Calculation Formula 1 below.

Capacity retention (%)=(100^{th} discharge capacity/1^{st} discharge capacity)×100 [Calculation Formula 1]

The capacity retention (%) calculated according to the above calculation formula are shown in Table 1.

[Methods of Evaluating Characteristics]

1) Measurement of the Interlayer Distance d₀₀₂ of Active Material

The interlayer distance d₀₀₂ of the graphite electrode active material was measured through X-ray diffraction (XRD).

2) Measurement of the Specific Surface Area of Active Material

The specific surface area of the graphite electrode active material was measured through Brunauer-Emmett-Teller (BET).

### Example 1

A composite anode was prepared by mixing 70% by weight of silicon oxide (SiO) with 30% by weight of high-speed charging type natural graphite (hereafter referred to as high-speed charging type graphite) obtained by supporting it in ethanol and treating it at −20° C. for 48 hours.

In the case of the high-speed charging type natural graphite prepared in Example 1 above, the interlayer distance is 3.363 Å, and the BET specific surface area (m 2/g) is 5.064.

### Example 2

A composite anode was prepared by mixing 50% by weight of silicon oxide (SiO) and 50% by weight of high-speed charging type natural graphite.

### Example 3

A composite anode was prepared by mixing 30% by weight of silicon oxide (SiO) and 70% by weight of high-speed charging type natural graphite.

### Example 4

A composite anode was prepared by mixing 10% by weight of silicon oxide (SiO) and 90% by weight of high-speed charging type natural graphite.

### Comparative Example 1

An anode was prepared using only high-speed charging type natural graphite (100% by weight) as an electrode active material.

2) Self-Extinguishing Time (SET, Sec/g)

Each of the electrolyte solutions prepared in Examples 5 to 9 was ignited with a torch, and after removing the torch, the self-extinguishing time (second, s) (SET) per weight (g) of the electrolyte solution was measured. It can be defined as non-flammable when SET<6, flame-retardant when 6<SET<20, and flammable when SET>20.

3) Charge and Discharge Test 2:

Manufactured were 2032 coin-type lithium half-cells composed of a composite anode which was prepared in Example 2, and in which 50% by weight of SiO and 50% by weight of high-speed charging type graphite were mixed, a lithium metal anode, the electrolyte solutions prepared in Examples 5 to 9 below, and a separator.

In Examples 5 to 7, after 2032 coin-type lithium half-cells composed of composite anodes in which 50% by weight of silicon oxide (SiO) and 50% by weight of high-speed charging type natural graphite were mixed using various flammable or nonflammable electrolyte solutions were charged up to 0.01 V with CC of 0.1 C-rate at room temperature (25° C.), charged with CV until the current reached 0.005 C, and discharged up to 1.5 V under CC conditions. Thereafter, the charge and discharge cycles were performed n times at 1 C at room temperature (25° C.) in a voltage range of 0.01 to 1.5 V to measure the discharge capacity per weight and the initial Coulombic efficiency under 0.1 C formation conditions, and the capacity retention rate was calculated according to Calculation Formula 2 below.

In Examples 8 to 9 also, 2032 coin-type lithium secondary batteries (half-cells) composed of a composite anode in which 50% by weight of silicon oxide (SiO) and 50% by weight of high-speed charging type natural graphite were mixed using various flammable or nonflammable electrolyte solutions were charged up to 0.01 V with CC of 0.1 to 0.5 C-rate in constant current (CC)/constant voltage (CV) mode at a high temperature (45° C.), charged with CV until the current reached 0.005 C, and discharged to 1.5 V under CC conditions. Thereafter, the charge and discharge cycles were performed n times at room temperature (25° C.) and in a 0.01 to 1.5 V voltage range at 1 C (1 hour required for charging) to measure discharge capacity per weight (specific gravimetric capacity) and the initial Coulombic efficiency under 0.1 C formation conditions, and the capacity retention rate was calculated according to Calculation Formula 2 below.

Capacity retention (%)=(n^{th} discharge capacity/1^{st} discharge capacity)×100 [Calculation Formula 2]

The n^{th} capacity retention (%) calculated according to the above calculation formula is shown in Table 2.

The specific experimental results are shown in Table 2 below.

### Example 5

An electrolyte solution for a lithium secondary battery was prepared by including 10 parts by weight of an FEC additive in 100 parts by weight of a 1 M LiPF₆ in EC:EMC (volume ratio of 3:7) electrolyte.

### Example 6

An electrolyte solution for a lithium secondary battery was prepared by including additives of 12.5 parts by weight of FEC, 1 part by weight of VC, and 1 part by weight of lithium difluorophosphate (LiPO₂F₂) in 100 parts by weight of a 1 M LiPF₆ in EC:EMC:dimethyl carbonate (DMC) (volume ratio 2:4:4) electrolyte.

### Example 7

An electrolyte solution for a lithium secondary battery was prepared by adding 2 parts by weight of VC, 2 parts by weight of FEC, and 0.4 parts by weight of icosafluoro-15-crown-5-ether (IF-CE) to 100 parts by weight of a 1 M LiPF₆ in EC:EMC:diethyl carbonate (DEC) (volume ratio 25:45:30) electrolyte.

### Example 8

An electrolyte solution for a lithium secondary battery was prepared by adding 2 parts by weight of VC and 2 parts by weight of FEC to 100 parts by weight of a 1 M LiPF₆ in PC (propylene carbonate):2,2,2-trifluoroethyl acetate (TFA) (volume ratio 3:7) electrolyte.

### Example 9

An electrolyte solution for a lithium secondary battery was prepared by adding 2 parts by weight of VC and 1 part by weight of FEC to 100 parts by weight of a 1 M LiPF₆ in PC:1-fluoroethyl methyl carbonate (FEMC):di-(2,2,2 trifluoroethyl)carbonate (DFDEC) (volume ratio 3:4:3) electrolyte.

4) Charge and Discharge Test 3:

Manufactured were 2032 coin-type lithium half-cells composed of a silicon alloy (Si—Fe)-high-speed charging type graphite composite anode in the case of Example 10, a nano-silicon (Si)-high-speed charging type graphite composite anode in the case of Example 11, a lithium metal anode, 1.0 M LiPF₆/EC:EMC (volume ratio of 3:7) electrolyte solutions including 10% by weight of an FEC additive based on the total weight of the electrolyte solution, and a separator. Low-speed (0.1 C) charge and discharge cycles were performed twice at room temperature (25° C.) in a voltage range of 0.01 to 1.5 V. The cycles included, after performing charging up to 0.01 V with CC of 0.1 C-rate, performing charging with CV until the current reached 0.005 C, and performing discharging to 1.5 V under CC conditions. Thereafter, the charge and discharge cycles were performed n times at 1 C at room temperature (25° C.) and in a voltage range of 0.01 to 1.5 V to measure the discharge capacity per weight and the initial Coulombic efficiency under 0.1 C formation conditions, and the capacity retention rate was calculated according to Calculation Formula 3 below.

Capacity retention (%)=(n^{th} discharge capacity/1^{st} discharge capacity)×100 [Calculation Formula 3]

The n^{th} capacity retention (%) calculated according to the above calculation formula is shown in Table 3.

Specific experimental results are shown in Table 3 below.

### Example 10

A composite anode was prepared by mixing 30% by weight of silicon alloy (Si—Fe) and 70% by weight of high-speed charging type natural graphite.

### Example 11

A composite anode was prepared by mixing 30% by weight of nano-sized silicon (Si) and 70% by weight of high-speed charging type natural graphite.

4) Charge and Discharge Test 4:

Manufactured were 2032 coin-type lithium half-cells composed of a silicon oxide (SiO)-high-speed charging type graphite composite anode and a silicon (Si)-high-speed charging type graphite composite anode in the case of Examples 12 to 15 and Comparative Example 1, a lithium metal electrode, 1.0 M LiPF₆/EC:EMC (volume ratio of 3:7) electrolyte solutions including 10% by weight of an FEC additive based on the total weight of the electrolyte solution, and a separator. The charge and discharge cycles were performed four times while changing the current from 0.1 C (10 hours required for charging) to 5 C (12 minutes required for charging) in a voltage range of 0.01 to 1.5 V. The cycles included, after performing charging up to 0.01 V with CC of 0.1 C to 5 C-rate, performing charging with CV until the current reached a current value 0.05 times the C-rate inputted during CC charging, and performing discharging to 1.5 V under CC conditions at the same current as the C-rate during charging. The discharge capacity was measured by performing the charge and discharge cycles at 0.1 to 5 C in a voltage range of 0.01 to 1.5 V.

In addition, the capacity retention rate was calculated according to Calculation Formula 4 below.

Capacity retention (%)=(discharge capacity according to C-rate/discharge capacity at 0.1 C)×100 [Calculation Formula 4]

The capacity retention rates according to the results of the charge and discharge test 4 were calculated and are shown in Table 4.

### Example 12

A composite anode was prepared by mixing 50% by weight of silicon oxide (SiO) and 50% by weight of high-speed charging type natural graphite.

### Example 13

A composite anode was prepared by mixing 10% by weight of silicon oxide (SiO) and 90% by weight of high-speed charging type natural graphite.

### Example 14

A composite anode was prepared by mixing 5% by weight of silicon oxide (SiO) and 95% by weight of high-speed charging type natural graphite.

### Example 15

A composite anode was prepared by mixing 30% by weight of a silicon alloy (Si—Fe) and 70% by weight of high-speed charging type natural graphite.

Table 1 below is results obtained by performing a charge and discharge test after applying anode active materials including SiO and graphite to a lithium secondary battery. The composite anode to which up to 70% by weight of SiO was applied also enables 1 C high speed charging and has a 100ₜₕ capacity retention rate as high as 94% or more.

5) Charge and Discharge Test 5:

Manufactured were 2032 coin-type lithium half-cells composed of silicon oxide (SiO)-high-speed charging type graphite and general natural graphite composite anodes in the case of Example 16 and Comparative Example 2, a lithium metal electrode, 1.0 M LiPF₆/EC:EMC (volume ratio of 3:7) electrolyte solutions including 10% by weight of an FEC additive based on the total weight of the electrolyte solution, and a separator. The charge and discharge cycles were performed three times while changing the charging current from 0.1 C (10 hours required for charging) to 600 C (6 seconds required for charging) in a voltage range of 0.01 to 1.5 V. The cycles included, after performing charging up to 0.01 V with CC of 0.1 C to 600 C-rate, performing charging with CV until the current reached a current value 0.2 times the C-rate inputted during CC charging, and performing discharging to 1.5 V under CC conditions by fixing the discharge C-rate to 1 C current. The discharge capacity was measured by performing the charge cycle at 0.1 C to 600 C and the discharge cycle at 1 C in a voltage range of 0.01 to 1.5 V.

At this time, the capacity retention rate was calculated based on the half-cell according to Calculation Formula 5 below.

Capacity retention (%)=(discharge capacity according to C-rate/discharge capacity at 0.1 C)×100 [Calculation Formula 5]

The capacity retention rates according to the results of the charge and discharge test 5 were calculated and are shown in Table 5.

In addition, the half-cell C-rates of Example 16 and Comparative Example 2 were converted to full cells and calculated according to Calculation Formula 6 below. The current density 1 C-rate of silicon oxide (SiO)-graphite composite anode//lithium metal electrode half-cells corresponds to 3 C of full cells composed of a silicon oxide (SiO)-graphite composite anode//a LiNi_{0.8}Co_{0.1}Mn_{0.1}O₂ (NCM811) high-nickel cathode, which corresponds to a 3 times faster charging speed.

C-rate based on full cell=(half-cell 1 C current density×corresponding C-rate)/full cell 1 C current density [Calculation Formula 6]

The capacity retention rates according to the results of the half-cell charge and discharge test 5 and the converted full cell-based C-rate and charging time are also shown in Table 5.

### Example 16

A composite anode was prepared by mixing 30% by weight of silicon oxide (SiO) and 70% by weight of high-speed charging type natural graphite.

### Comparative Example 2

A composite anode was prepared by mixing 30% by weight of silicon oxide (SiO) and 70% by weight of general natural graphite.

TABLE 1

| | Composite anode | | | | |
|---|---|---|---|---|---|
| | composition ratio | | Charge and discharge test 1 | | |
| | | High-speed | 1^{st} | 100^{th} | Initial |
| | | charging type | discharge | capacity | Coulombic |
| | SiO | graphite | capacity | retention | efficiency |
| | (% by | (% by | (1 C) | (1 C) | (1 C) |
| | weight) | weight) | (mAh/g) | (%) | (%) |
| Example 1 | 70 | 30 | 1225 | 97 | 79 |
| Example 2 | 50 | 50 | 928 | 97 | 75 |
| Example 3 | 30 | 70 | 706 | 94 | 81 |
| Example 4 | 10 | 90 | 501 | 92 | 72 |
| Comparative | 0 | 100 | 392 | 96 | 84 |
| Example 1 | | | | | |

Table 2 below shows the results of performing the charge and discharge test after manufacturing lithium secondary batteries using an anode active material containing 50% by weight of SiO and 50% by weight of graphite by changing the electrolyte solution. Since 1 C high-speed charging is possible even in various flammable and non-flammable electrolyte solutions, and 50% by weight of SiO was applied, it is possible to obtain high capacities of the composite anodes.

TABLE 2

| | Evaluation of electrolyte | | Charge and discharge test 2 | | |
|---|---|---|---|---|---|
| | solution properties | | 1^{st} | | Initial |
| | | Whether it | discharge | n^{th} capacity | Coulombic |
| | | is | capacity | retention | efficiency |
| | SET | flammable | (1 C) | (1 C) | (1 C) |
| | (sec/g) | or not | (mAh/g) | (%) | (%) |
| Example 5 | 55 | Flammable | 928 | 81(153^{rd} cycle ) | 74.9 |
| Example 6 | 71 | Flammable | 882 | 81(184th cycle) | 73.8 |
| Example 7 | 57 | Flammable | 869 | 79(100th cycle) | 77.5 |
| Example 8 | 0 | Non- | 921 | 89(30th cycle) | 74.3 |
| | | flammable | | | |
| Example 9 | 0 | Non- | 966 | 99(30th cycle) | 72.4 |
| | | flammable | | | |

Table 3 below shows the results of performing the charge and discharge test after applying an anode active materials containing Si and graphite to lithium secondary batteries. It can be seen that 1 C high-speed charging of the composite anodes prepared through the application of various Si anode active materials is possible.

TABLE 3

| | Composite anode | | | | |
|---|---|---|---|---|---|
| | composition ratio (%) | | Charge and discharge test 3 | | |
| | | High-speed | 1^{st} | | Initial |
| | | charging type | discharge | n^{th} capacity | Coulombic |
| | Si | graphite | capacity | retention | efficiency |
| | (% by | (% by | (1 C) | (1 C) | (1 C) |
| | weight) | weight) | (mAh/g) | (%) | (%) |
| Example | 30 | 70 | 684 | 96(30th cycle) | 77.4 |
| 10 | | | | | |
| Example | 30 | 70 | 1331 | 89(30th cycle) | 87.9 |
| 11 | | | | | |

Table 4 below shows the experimental results of checking high-speed charging performance after applying anode active materials containing SiO and graphite to lithium secondary batteries as shown in Table 1 above. The composite anodes to which a large amount of SiO was applied enable high-speed charging even at 3 C (9 C (charging for 1.6 minutes) in the case of SiO-high-speed charging type graphite/NCM811 full cells) and have a high capacity retention rate of 94% or more compared to the capacity at 0.1 C.

TABLE 4

| | | Capacity retention (%) | | | | | |
|---|---|---|---|---|---|---|---|
| | Discharge | 0.1 C | 0.2 C | 0.5 C | 1 C | 2 C | 3 C |
| | capacity | (charging | (charging | (charging | (charging | (charging | (charging |
| | 0.1 C | for 10 | for 5 | for 2 | for 1 | for 30 | for 20 |
| | (mAh/g) | hours) | hours) | hours) | hour) | minutes) | minutes) |
| Example 12 | 903 | 100 | 100 | 100 | 99 | 97 | 94 |
| Example 13 | 501 | 100 | 99 | 98 | 97 | — | — |
| Example 14 | 400 | 100 | 100 | 100 | 100 | — | — |
| Example 15 | 659 | 100 | 99 | 96 | 96 | 95 | — |

Table 5 below is the experimental results of checking ultrahigh-speed charging performance after applying anode active materials containing SiO and graphite to lithium secondary batteries as shown in Table 1 above. The high-speed charging type graphite composite anodes to which a high content of SiO was applied enable ultrahigh-speed charging in second units up to half-cell 600 C (charging for 6 seconds) and full cell 1800 C (charging for 2 seconds) compared to general graphite composite anodes, and have very high capacity retention rates of 85% or more compared to the capacity at 0.1 C.

TABLE 5

| Discharge capacity at 0.1 C | | | | | | | | | |
|---|---|---|---|---|---|---|---|---|---|
| (charging for 10 hours) | | | | | | | | | |
| (mAh/g) | | | | | | | | | |
| | | | | Based on full cell | | | | | Comparative |
| Based on half-cell | | | | | | Time | | Example 16 | Example 2 |
| | | Time required | | | | required for | | 705 | 692 |
| C-rate | | for charging | | C-rate | | charging | | Capacity retention (%) | |
| 0.1 | C | 10 | hours | 0.3 | C | 3.3 | hour | 100 | 100 |
| 0.2 | C | 5 | hours | 0.6 | C | 1.6 | hour | 99 | 99 |
| 0.5 | C | 2 | hours | 1.5 | C | 40 | minute | 98 | 97 |
| 1 | C | 1 | hour | 3 | C | 20 | minute | 97 | 97 |
| 2 | C | 30 | minutes | 6 | C | 10 | minute | 95 | 95 |
| 3 | C | 20 | minutes | 9 | C | 6.7 | minute | 94 | 94 |
| 4 | C | 15 | minutes | 12 | C | 5 | minute | 94 | 93 |
| 5 | C | 12 | minutes | 15 | C | 4 | minute | 93 | 92 |
| 10 | C | 6 | minutes | 30 | C | 2 | minute | 93 | 91 |
| 15 | C | 4 | minutes | 45 | C | 1 minute 30 second | | 92 | 90 |
| 20 | C | 3 | minutes | 60 | C | 1 | minute | 91 | 90 |
| 30 | C | 2 | minutes | 90 | C | 40 | second | 91 | 89 |
| 40 | C | 1 minute 30 seconds | | 120 | C | 30 | second | 90 | 88 |
| 50 | C | 1 minute 12 seconds | | 150 | C | 24 | second | 90 | 87 |
| 60 | C | 1 | minute | 180 | C | 20 | second | 90 | 87 |
| 70 | C | 51 | seconds | 210 | C | 17 | second | 89 | 86 |
| 80 | C | 45 | seconds | 240 | C | 15 | second | 89 | — |
| 90 | C | 40 | seconds | 270 | C | 13 | second | 88 | — |
| 100 | C | 36 | seconds | 300 | C | 12 | second | 88 | — |
| 150 | C | 24 | seconds | 450 | C | 8 | second | 88 | — |
| 200 | C | 18 | seconds | 600 | C | 6 | second | 88 | — |
| 250 | C | 14 | seconds | 750 | C | 4.8 | second | 87 | — |
| 300 | C | 12 | seconds | 900 | C | 4 | second | 87 | — |
| 350 | C | 10 | seconds | 1050 | C | 3.4 | second | 87 | — |
| 400 | C | 9 | seconds | 1200 | C | 3 | second | 86 | — |
| 450 | C | 8 | seconds | 1350 | C | 2.7 | second | 86 | — |
| 500 | C | 7 | seconds | 1500 | C | 2.4 | second | 86 | — |
| 550 | C | 7 | seconds | 1650 | C | 2.2 | second | 85 | — |
| 600 | C | 6 | seconds | 1800 | C | 2 | second | 85 | — |

Although preferred embodiments of the present invention have been described in detail above, the scope of rights of the present invention is not limited thereto, and various modifications and improved forms made by those skilled in the art using the basic concept of the present invention defined in the following claims also fall within the scope of the rights of the present invention.

1. An anode active material including a graphite active material and a silicon-based active material,
wherein the graphite active material has an interlayer distance d₀₀₂ increased by 0.001 Å to 0.003 Å compared to a general graphite active material.

2. The anode active material of claim 1, wherein the silicon-based active material and the graphite active material are included at a weight ratio of 1:99 to 99:1.

3. The anode active material of claim 1, wherein the graphite active material is a natural graphite active material or an artificial graphite active material.

4. The anode active material of claim 3, wherein the natural graphite active material has an interlayer distance d₀₀₂ of 3.360 Å to 3.365 Å.

5. The anode active material of claim 1, wherein the silicon-based active material is selected from the group consisting of silicon (Si), silicon oxides, silicon alloys (alloys), silicon nanotubes, silicon nanowires, and carbon composites thereof and mixtures thereof.

6. The anode active material of claim 1, wherein the lithium secondary battery comprising the anode active material has a discharge capacity per weight of 350 to 3,200 mAh/g during 0.1 C charging.

7. The anode active material of claim 1, wherein the lithium half-cell comprising the anode active material has a discharge capacity per weight of more than 350 mAh/g to less than 2,500 mAh/g during 10 C charging (charging for 6 minutes) and enables a 0.1 C to 600 C charge (charging for 6 seconds) cycle.

8. The anode active material of claim 1, wherein the graphite active material has a BET specific surface area increased by 127% or more.

9. An anode for a secondary battery, comprising the anode active material according to claim 1.

10. A secondary battery comprising the anode for a secondary battery according to claim 9.

11. The secondary battery of claim 10, wherein the anode for a secondary battery has a discharge capacity per weight of 350 to 3,200 mAh/g during 0.1 C charging.

12. The secondary battery of claim 10, wherein the anode for a secondary battery has a discharge capacity per weight of more than 350 mAh/g to less than 2,500 mAh/g during 10 C charging, and enables a 1 C to 1,800 C charge (charging for 2 seconds) cycle.

13. A method for preparing an anode active material, comprising the steps of:
supporting graphite in an organic solvent;
low-temperature treating graphite supported in the organic solvent;
drying low-temperature treated graphite; and
mixing dried graphite with a silicon-based active material,
wherein graphite has an interlayer distance d₀₀₂ increased by 0.001 Å to 0.003 Å.

14. The method of claim 13, wherein the organic solvent is selected from the group consisting of a linear alcohol-based organic solvent, a linear carbonate-based organic solvent, a cyclic carbonate-based organic solvent, a linear ester-based organic solvent, a ketone-based organic solvent, and mixtures thereof.

15. The method of claim 13, wherein the low-temperature treatment is performed at 0 to −40° C. for 0.1 to 168 hours.
